(19) United States
(12) Patent Application Publication
(10) Pub. No.: US 2015/0172598 A1
(43) Pub. Date: Jun. 18, 2015

(54) SYSTEM AND METHOD FOR PROVIDING VIDEO SUPPORT TO LEGACY VOIP PHONES USING COMPANION DISPLAY DEVICES

(71) Applicant: HCL Technologies Limited, Chennai (IN)

(72) Inventors: Abhishek Suman, Ghaziabad (IN); Nitin Garg, Delhi (IN)

(73) Assignee: HCL Technologies Limited

(21) Appl. No.: 14/529,184

(22) Filed: Oct. 31, 2014

(30) Foreign Application Priority Data
Dec. 18, 2013 (IN) 5934/CHE/2013

(51) Int. Cl. H04N 7/14

(52) U.S. Cl. CPC H04N 7/147

(57) ABSTRACT

Disclosed herein is a method and system for providing video support for legacy Internet Protocol (IP) phones. In this system, a Companion Display Device (CDD) is configured to communicate with the legacy IP phone by registering the CDD with the legacy IP phone. Further, whenever a call initiation request is detected, the legacy IP phone initiates the CDD. The CDD then displays incoming video streams received from a communication device with which the legacy IP phone has established video call connection. The CDD further captures and transmits video streams to the legacy IP phone, which in turn is transmitted to the communication device over the IP network.

The present application is based on, and claims priority from, Indian Complete Application number 5934/CHE/2013 filed on 18 Dec. 2013, the disclosure of which is hereby incorporated by reference herein.

### TECHNICAL FIELD

The embodiments herein relate to audio and video communication systems and, more particularly to providing video support for legacy Voice Over Internet Protocol (i.e., VOIP non-video capable) phones using a Companion Display Device (CDD).

### BACKGROUND

Over the years, Internet Protocol (IP) telephony has evolved from simple phones which support only audio calls to advanced communication devices that can support more advanced features such as video calling, instant messaging, audio and video conferences and so on. For example, communication devices such as personal computers, laptops, tablets and so on have been equipped with devices such as webcams and microphones that allow them to make and receive video calls over IP networks such as Internet using different applications. Also, there has been a rapid increase in the development and implementation of communications networks and their associated systems. This rapid improvement is further changing the way in which people interact with each other.

To make use of these new features like video calling, video conference and so on, on the existing communication devices (such as legacy IP phones with non-video capability), substantial enhancements have to be done in the hardware as these features are supported by new hardware only. In other words, users who are using the existing hardware have to upgrade the infrastructure including their end devices to use the updated features like video calling.

In most of the cases, while upgrading the existing communication systems, new hardware has to be implemented both in the network side and in the end equipments side. Hence, any development in the systems which involve huge number of users (for example call centers) cannot take the advantage of upgrading as it results in huge investment and maintenance cost.

### SUMMARY

In view of the foregoing, an embodiment herein provides a system for providing video support for a legacy Internet Protocol (IP) phone, the system comprises of a Companion Display Device (CDD). The CDD is configured to communicate with the legacy IP phone to provide the video support, wherein the CDD is further configured for displaying incoming video streams, and capturing video streams to be transmitted.

Embodiments further disclose a method for providing video support for legacy IP phone. The method comprises of configuring the legacy IP phone with a Companion Display Device (CDD). Further, upon detecting a call initiation request, the legacy IP phone initiates the configured CDD. The CDD then displays incoming video streams and also captures video streams to be transmitted.

These and other aspects of the embodiments herein will be better appreciated and understood when considered in conjunction with the following description and the accompanying drawings.

### BRIEF DESCRIPTION OF THE FIGURES

The embodiments herein will be better understood from the following detailed description with reference to the drawings, in which:

FIG. 1 illustrates a block diagram of a video enabling system environment, as disclosed in the embodiments herein;

FIG. 2 is a block diagram that shows various components of video enabling system, as disclosed in the embodiments herein;

FIG. 3 is a block diagram that shows various components of Companion Display Device (CDD) support system, as disclosed in the embodiments herein;

FIG. 4 is a flow diagram which shows various steps involved in the process of providing video support to legacy Internet Protocol (IP) phone by using CDD, as disclosed in the embodiments herein;

FIG. 5 is a flow diagram which shows various steps involved in the process of capturing and transmitting video streams using CDD, as disclosed in the embodiments herein; and

FIG. 6 is a flow diagram which shows various steps involved in the process of displaying incoming video streams using CDD, as disclosed in the embodiments herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

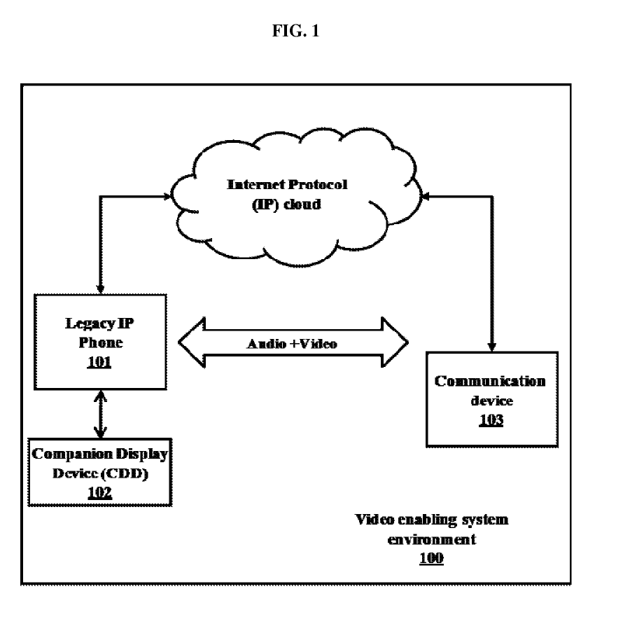

The embodiments herein disclose a system and method for providing video support to legacy Internet Protocol (IP) phones by using a Companion Display Device (CDD). Referring now to the drawings, and more particularly to FIGS. 1 through 6, where similar reference characters denote corresponding features consistently throughout the figures, there are shown embodiments.

FIG. 1 illustrates a block diagram of a video enabling system environment, as disclosed in the embodiments herein. The video enabling system environment 100 comprises of a legacy IP phone 101, a Companion Display Device (CDD) 102 and a communication device 103. The legacy IP phone 101 further comprises of a video enabling system 101.a. The CDD 102 further comprises of a CDD support system 102.a.

The legacy IP phone 101 can be any standard telephone that supports voice calls over IP with no video support. The legacy IP phone 101 contains a video enabling system 101.a which can be configured to communicate with the CDD 102 to provide video support and to the Legacy IP Phone 101 to make and receive video call (s). In an embodiment, the video enabling system 101.a can be a firmware which can be installed in the legacy IP phone 101 without requiring upgradation of the legacy IP phone 101 hardware.

The CDD 102 can be configured to display video frames transmitted from the Legacy IP Phone 101 using an associated display interface. The display interface associated with the CDD 102 may be any commonly available display device. For example, the display interface associated with the CDD 102 can be a Personal computer, a tablet, or phablet and so on. The CDD 102 contains a CDD support system 102.a that interacts with video enabling system 101.a of the Legacy IP phone 101 to provide video support. The CDD 102 may be further configured to capture video using an associated video capturing interface such as a camera, which may be then transmitted to the other communication device which is involved in video call with the Legacy IP Phone 101.

The communication device 103 can be any device such as but not limited to mobile phone, smart phone, phablet and land telephone that are used for communication purpose, which is configured to establish a video call session with the Legacy IP phone 101. In various embodiments, the video call may be initiated from the Legacy IP phone 101 or the communication device 103 using normal video call making/receiving procedures.

When the video call (call) is initiated from the communication device 103, the video and audio streams are transmitted to the Legacy IP phone through communication channels. At the receiving end, the system firmware present in the legacy IP phone 101 receives the incoming signals and the video enabling system 101.a present in the legacy IP phone 101 provides necessary video support to the incoming call with the help of the CDD 102, wherein the video support involves displaying video streams transmitted from the communication device 103 and capturing video streams that are to be transmitted to the communication device 103. Similarly, when the call is initiated from the Legacy IP phone 101, the CDD 102 is used to provide video support to the Legacy IP phone 101.

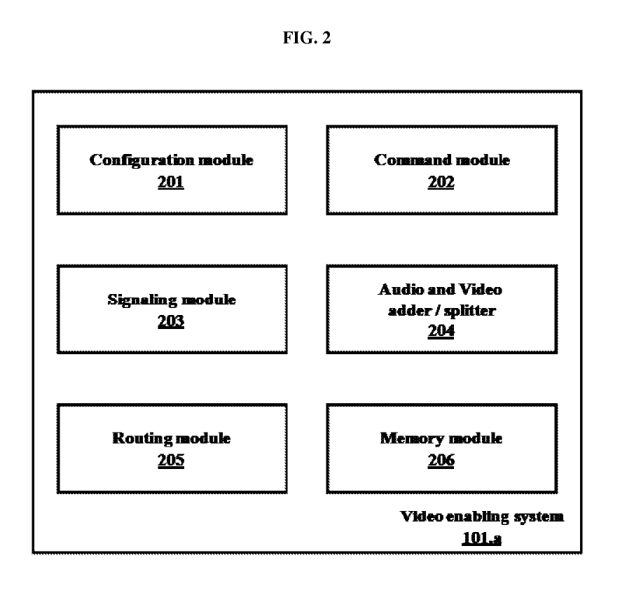

FIG. 2 is a block diagram that shows various components of video enabling system, as disclosed in the embodiments herein. The video enabling system 101.a comprises of a configuration module 201, a command module 202, a signaling module 203, an audio and video adder/splitter 204, a routing module 205 and a memory module 206.

The configuration module 201 provides necessary interfaces for configuring the CDD 102 details with the legacy IP phone 101 and further stores them in the memory module 206. In an embodiment, the configuration details may include but not limited to video capabilities, MAC address and IP address. Furthermore, the configuration module 201 can automatically detect the presence of new CDD 102 using ‘device discovery’ message whenever the legacy IP phone 101 is turned on.

The command module 202 sends a ‘registration request’ to the CDD 102 in order to register the CDD 102 with the legacy IP phone 101. Further, in response to the registration request sent, the command module 202 may receive ‘registration acknowledgement’ from the CDD 102 which indicates success or failure of the registration process. Further, in a preferred embodiment, the command module 202 is responsible for initiating the CDD 102 while making or receiving a call, by sending a “START message” to the CDD. The command module 202 may also send separate command (s) to prompt the CDD 102 to capture video frames, which is then transmitted to the communication device 103.

The signaling module 203 takes care of signaling issues related to video capturing or video display based on the commands received from the command module 202. The signaling module 203 sends appropriate commands to the audio and video adder/splitter 204 to add audio and video streams that have to be transmitted to the communication device 103 and to split audio/video streams received from the communication device 103. The signalling module 203 is further responsible for managing signalling procedures involved in call making and receiving processes between the Legacy IP phone 101 and the communication device (s) 103. Furthermore, the signaling module 203 sends commands to the routing module 205 to route the incoming video to the CDD 102.

The audio and video adder/splitter 204 receives signals from the signaling module 203 and performs the actions of adding or splitting the audio/video streams accordingly. When the call is in progress, the audio/video frames received from the communication device 103 is to be split so as to route/redirect the video streams to the CDD 102. Similarly audio from the Legacy IP phone 101 and video captured using the CDD 102 so as to transmit to the communication device 103. These actions are performed by the audio and video adder/splitter 204. The audio and video adder/splitter 204 may use any suitable mechanism to add and/or split the audio/video streams. The routing module 205 receives commands from the signaling module 203 and routes the incoming video stream from the communication device 103 to the CDD 102 using any suitable known mechanism. In an embodiment, the routing module 205 fetches the video stream to be routed to the CDD 102, form the audio and video adder/splitter 204.

The memory module 206 stores the information that is required for the functioning of the video enabling system 101.a in the legacy IP phone 101. In an embodiment, the information can be configuration details of the registered CDD 102 and any such information.

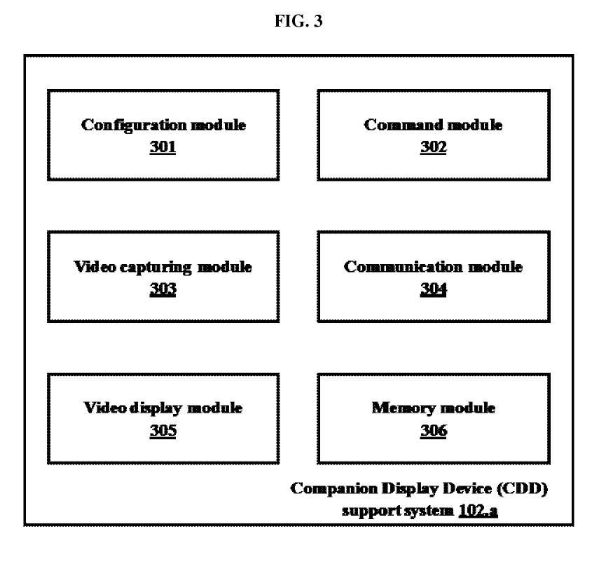

FIG. 3 is a block diagram that shows various components of Companion Display Device (CDD) support system, as disclosed in the embodiments herein. The CDD support system 102.a comprises of a configuration module 301, a command module 302, a video capturing module 303, a communication module 304, a video display module 305 and a memory module 306.

The configuration module 301 provides necessary interfaces for configuring the legacy IP phone 101 details with the CDD 102 and further stores them in the memory module 306. In an embodiment, the configuration details may include but not limited to MAC address and IP address. Furthermore, the configuration module 301 can automatically detect the presence of new legacy IP phones 101 using the ‘device discovery’ message whenever the CDD 102 is turned on.

The command module 302 sends the ‘registration request’ to the legacy IP phone 101 in order to configure the legacy IP phone 101 with the CDD 102. The command module 302 may further receive ‘registration acknowledgement’ from the legacy IP phone 101 which indicates a success or failure of the registration process. Further, the command module 302 alert the user through a status message of suitable format, indicating status of the registration process, using the configuration module 301.

The video capturing module 303 receives video capturing commands from the video enabling system 101.a of the legacy IP phone 101 and further captures the video using the hardware present in the CDD 102. For example, the video capturing module 303 may use the camera component such as a webcam associated with the CDD 102 to capture video. Furthermore, the video capturing module 303 sends the captured video to the legacy IP phone 101 through the communication module 304.

The communication module 304 receives video from the video capturing module 303 and further transmits it to the legacy IP phone 101 by using any suitable communication channel. In various embodiments, the communication channel may be wired or wireless. The communication module 304 also receives incoming video from the routing module 205 of the legacy IP phone 101 and further sends it to the video display module 305 to display the video to the user.

The video display module 305 receives video from the communication module 304 and further displays the video using suitable output interface present in the CDD 102. In an embodiment, the video display module 305 may use browsers that present in the CDD 102 to display the received video. This can be done automatically by enabling the browser associated with the CDD 102.

The memory module 306 stores the information that is required for the functioning of the CDD support system 102.a in the CDD 102. In an embodiment, the information can be configuration details of the registered legacy IP phone 101, commands to enable browsers and so on.

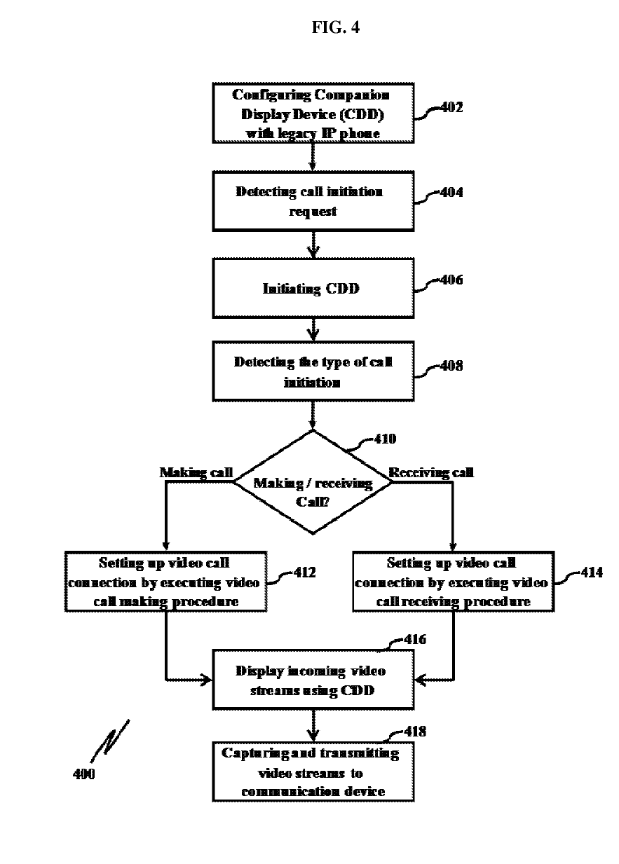

FIG. 4 is a flow diagram which shows various steps involved in the process of providing video support to legacy Internet Protocol (IP) phone by using CDD, as disclosed in the embodiments herein. In order to enable video support to the legacy IP phone 101, initially the CDD 102 is to be registered with the Legacy IP phone 101 by configuring (402) CDD specific parameters such as but not limited to MAC address, and IP address of the CDD 102 with the legacy IP phone 101. In an embodiment, the CDD support system 102.a is installed with the CDD 102 so that the CDD 102 provides its video services to the legacy IP phone 101. In another embodiment, the video enabling system 101.a is installed in the legacy IP phone 101 so that the legacy IP phone 101 can make use of video services provided by the CDD 102. Further, registering (i.e., configuring) the CDD 102 with the legacy IP phone 101 can be achieved in two ways.

1) Manual Registration:

This registration process can be initiated either from the legacy IP phone 101 end or from the CDD 102 end. When the registration process is initiated from the legacy IP phone 101, initially, certain CDD specific parameters are to be manually configured with the legacy IP phone 101. In an embodiment, the parameter can be an IP address or MAC ID or host name of the CDD 102, and value of at least one parameter may be unique for each CDD 102. In another embodiment, the configuration module 201 present in the video enabling system 101.a of the legacy IP phone 101 provides necessary interfaces to configure the CDD 102 details to the legacy IP phone 101. Later, the configuration module 201 stored the details in the memory module 206.

Later, the command module 202 fetches the configured CDD 102 details from the memory module 206 and sends the ‘device registration’ request to the CDD 102. The command module 302 of the CDD support system 102.a receives this request and further responds with a registration acknowledgement. The command module 202 in the video enabling system 101.a receives the acknowledgement and finally sends a confirmation alert to the user through the configuration module 201.

When the registration process is initiated form the CDD 102, the legacy IP phone 101 details are to be manually configured with the CDD 102. In an embodiment, the details can be an IP address or MAC ID or host name of the legacy IP phone 101. In another embodiment, the configuration module 301 present in the CDD support system 102.a of the CDD 102 provides necessary interfaces to configure the legacy IP phone 101 details to the CDD 102. Later, the configuration module 301 stores the details in the memory module 306.

Later, the command module 302 fetches the configured legacy IP phone 101 details from the memory module 306 and sends the ‘device registration’ request to them. The command module 202 of the video enabling system 101.a receives this request and further responds with the ‘registration acknowledgement’. The command module 302 in the CDD support system 102.a receives the acknowledgement and finally sends a confirmation alert to the user through the configuration module 201.

2) Automatic Registration:

This registration process can be initiated either from the legacy IP phone 101 end or from the CDD 102 end. When the automatic registration process is initiated form the legacy IP phone 101 end, the configuration module 201 of the video enabling system 101.a sends a ‘device discovery’ message to all available CDDs 102 over the network automatically when the legacy IP phone 101 is turned on. Then, the CDDs 102 present in the network receive the message through the command module 302 and further send the ‘device registration’ request to the legacy IP phone 101. Later, the command module 202 present in the legacy IP phone 101 receives these requests and responds with the ‘registration acknowledgement’. Now, the command module 302 in the CDD 102 receives the acknowledgement and finally sends a confirmation alert to the user through the configuration module 301.

When the automatic registration process is initiated form the CDD 102 end, the configuration module 301 of the CDD support system 102.a sends a ‘device discovery’ message to all available legacy IP phones 101 over the network automatically when the CDD 102 is turned on. Then, the legacy IP phones 101 present in the network receive the message through the command module 202 and further send the ‘device registration’ request to the CDD 102. Later, the command module 302 present in the CDD 102 receives these requests and responds with the ‘registration acknowledgement’. Now, the command module 202 in the legacy IP phone 101 receives the acknowledgement and finally sends a confirmation alert to the user through the configuration module 201.

In an embodiment, multiple CDDs 102 may be configured with the legacy IP phone 101. After successful registration, the configuration module 201 of the legacy IP phone 101 displays all configured CDD 102 details, so that the user can select a suitable CDD 102 based on his interest (while making or receiving video calls using the legacy IP phone 101), using a suitable user interface. Later, when the user tries to initiate a call request (either making or receiving a call) through the legacy IP phone 101, the command module 202 of the legacy IP phone 101 detects (404) the call request in order to provide video support accordingly.

Further, the command module 202 initiates (406) the CDD 102 by sending a ‘START message’ to the CDD 102. The CDD 102, upon initiation, prepares to capture and/or display video streams and to receive and/or transmit video streams. In a preferred embodiment, the CDD 102 is initiated only when the call is a video call i.e. when the call requires video support.

In various embodiments, the Legacy IP phone 101 may be making or receiving the call. If the Legacy IP phone 101 is making the call, then the video call is set up (412) by executing a video call making procedure which involves normal signalling procedures from the Legacy IP phone 101. If the Legacy IP phone 101 is receiving the call, then the video call is set up (414) by executing a video call receiving procedure which involves normal signalling procedures from the Legacy IP phone 101.

Further, when the call is initiated, CDD 102 provides video support to the Legacy IP phone 101, which involves the CDD displaying (416) video streams received from the communication device 103 to the user and capturing (418) video streams which are to be transmitted to the communication device 103. The various actions in method 400 may be performed in the order presented, in a different order or simultaneously. Further, in some embodiments, some actions listed in FIG. 4 may be omitted.

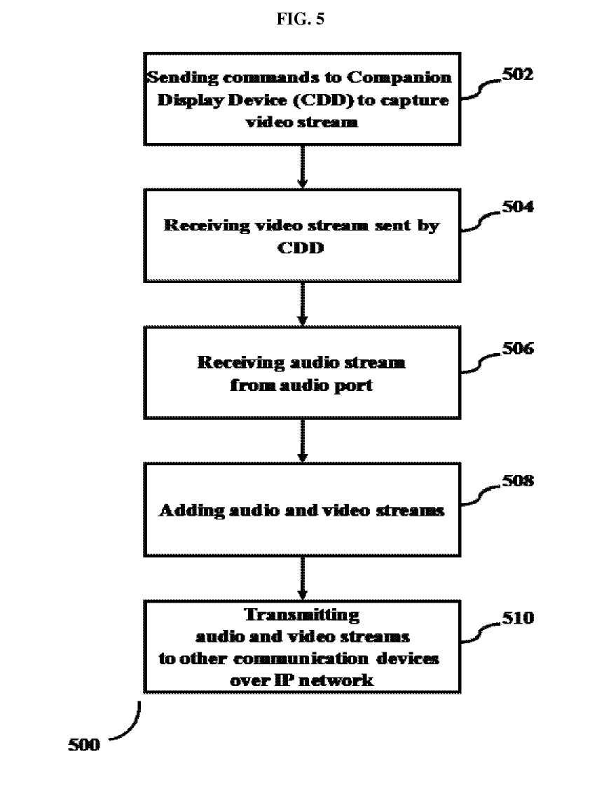

FIG. 5 is a flow diagram which shows various steps involved in the process of capturing and transmitting video streams using CDD, as disclosed in the embodiments herein. After initiating the CDD 102 upon making/receiving a call, the signaling module 203 sends (502) appropriate commands to the CDD 102 to start capturing the video. The command module 302 present in the CDD support system 102.a of the CDD 102 receives these commands and further sends them to the video capturing module 303 which starts capturing video streams using existing hardware present in the CDD 102. Furthermore, the communication module 304 present in the CDD support system 102.a transmits the captured video streams to the legacy IP phone 101.

Now, the signaling module 203 present in the video enabling system 101.a of the legacy IP phone 101 receives (504) the video stream coming from the communication module 304. Further the signaling module 203 also receives (506) audio streams from the audio receiving port of the legacy IP phone 101 simultaneously. The signalling module 203 further sends the received audio streams and video streams to the audio and video adder/splitter 204. Then, the audio and video adder/splitter 204 adds (508) the received audio and video streams using any suitable mechanism and transmits (510) the combined signal over IP network to the communication device 103. In one embodiment, the audio and video streams may be transmitted together to the communication device 103. In another embodiment, the audio and video streams may be transmitted separately to the communication device 103. The various actions in method 500 may be performed in the order presented, in a different order or simultaneously. Further, in some embodiments, some actions listed in FIG. 5 may be omitted.

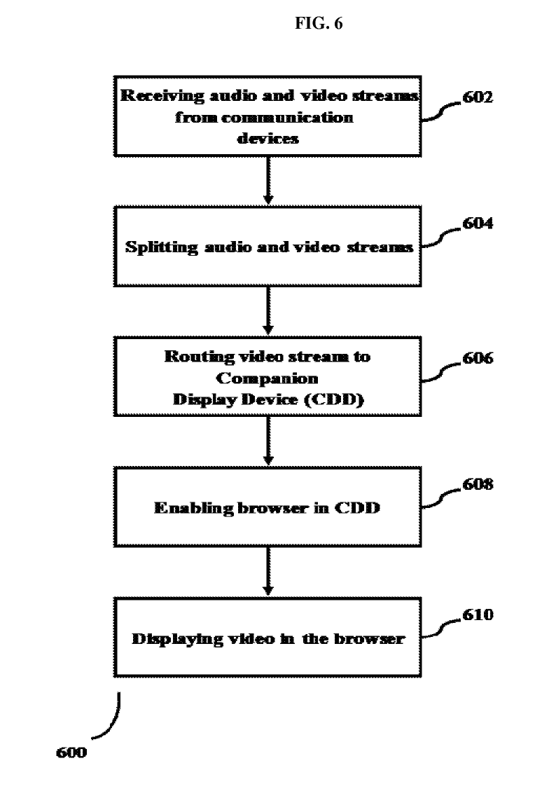

FIG. 6 is a flow diagram which shows various steps involved in the process of displaying incoming video streams using CDD, as disclosed in the embodiments herein. When a call is initiated, audio and video streams received from the communication device 103 terminate at the Legacy IP phone 101. The audio and video adder/splitter 204 in the Legacy IP phone 101, upon receiving corresponding commands, splits (604) the received audio/video stream to separate audio and video streams. The audio stream is then delivered to the user using audio output interface associated with the Legacy IP phone 101. The video stream is to be routed to the CDD 102 to display to the user. The routing module 205 routes (606) the video stream to the CDD 102 using any suitable known mechanism. Further, the communication module 304 present in the CDD 102 receives the video stream and forwards it to the video display module 305 to display the received video stream.

On receiving the video stream, the video display module 305 displays the video using suitable output interface that present in the CDD 102. In an embodiment, the video display module 305 enables (608) the browsers that are present in the CDD 102 automatically and further displays (610) the video to the user. The various actions in method 600 may be performed in the order presented, in a different order or simultaneously. Further, in some embodiments, some actions listed in FIG. 6 may be omitted.

The video enabling system environment 100 can also be used in other scenarios such as but not limited to video conferences, remote presentations and remote teachings. Moreover, the video enabling system environment 100 can be easily implemented and used on any communication networks which support video calling features as this environment requires no specialized equipments or hardware in the network in which it is implemented.

The embodiments disclosed herein can be implemented through at least one software program running on at least one hardware device and performing network management functions to control the network elements. The network elements shown in FIG. 1 to FIG. 3 include blocks which can be at least one of a hardware device, or a combination of hardware device and software module.

The embodiment disclosed herein specifies a system for providing video support to legacy IP phones. The mechanism allows using a CDD with the legacy IP phone that enables video support in the legacy IP phone, providing a system thereof. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in e.g. Very high speed integrated circuit Hardware Description Language (VHDL) another programming language, or implemented by one or more VHDL or several software modules being executed on at least one hardware device. The hardware device can be any kind of device which can be programmed including e.g. any kind of computer like a server or a personal computer, or the like, or any combination thereof, e.g. one processor and two FPGAs. The device may also include means which could be e.g. hardware means like e.g. an ASIC, or a combination of hardware and software means, e.g. an ASIC and an FPGA, or at least one microprocessor and at least one memory with software modules located therein. Thus, the means are at least one hardware means and/or at least one software means. The method embodiments described herein could be implemented in pure hardware or partly in hardware and partly in software. The device may also include only software means. Alternatively, the embodiments herein may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

We claim:

1. A system for providing video support for a legacy Internet Protocol (IP) phone, said system comprises of:
a Companion Display Device (CDD) configured to communicate with said legacy IP phone to provide said video support, wherein said CDD is further configured for:
displaying incoming video streams; and
capturing video streams to be transmitted.

2. The system as in claim 1 is further configured to provide said video support to said Legacy IP phone using said CDD by:
configuring said CDD with said legacy IP phone; and
initiating said configured CDD upon detecting a call initiation request;

3. The system as in claim 2, wherein system is further configured to configure said CDD with said legacy IP phone by registering said CDD with said legacy IP phone.

4. The system as in claim 3, wherein said system provides means for manually registering said CDD with said legacy IP phone.

5. The system as in claim 4, wherein said system is further configured to provide means for manually registering said CDD with said legacy IP phone by:
configuring at least one parameter specific to said Legacy IP phone with said CDD;
sending a device registration request from said CDD to said legacy IP phone;
registering said CDD with said legacy IP phone, upon receiving said device registration request from said CDD; and
sending a registration acknowledgement to said CDD from said legacy IP phone.

6. The system as in claim 3, wherein said system provides means for automatically registering said CDD with said legacy IP phone.

7. The system as in claim 6, wherein said system is further configured to provide means for initiating said automatic registering of said CDD with said legacy IP phone, from said legacy IP phone.

8. The system as in claim 7, wherein said system is further configured to initiate said automatic registering of said CDD with said legacy IP phone, from said legacy IP phone by:
sending a device discovery message to at least one CDD from said legacy IP phone, using a configuration module in said legacy IP phone;
receiving said device discovery message from said legacy IP phone using a command module in said at least one CDD;
registering said legacy IP phone with each of said plurality of CDDs, wherein said registration involves configuring at least one parameter specific to said Legacy IP phone with said at least one CDD; and
sending registration acknowledgement to said legacy IP phone using a command module of said at least one CDD.

9. The system as in claim 6, wherein said system is further configured to provide means for initiating said automatic registering of said CDD with said legacy IP phone, from said CDD.

10. The system as in claim 9, wherein said system is further configured to initiate said automatic registering of said CDD with said legacy IP phone, from said CDD by:
sending a device discovery message to at least one legacy IP phone from said CDD, using a configuration module in said CDD;
receiving said device discovery message from said CDD using a command module in said at least one legacy IP phone;
registering said CDD with said at least one legacy IP phone, wherein said registration involves configuring at least one parameter specific to said CDD with said at least one legacy IP phone; and
sending registration acknowledgement to said CDD using a command module of said at least one legacy IP phone.

11. The system as in claim 2, wherein said system is further configured to initiate said CDD by sending a START message from said legacy IP phone.

12. The system as in claim 1, wherein said system is further configured to display said incoming video streams using said CDD by:
terminating video/audio streams received from a communication device at said legacy IP phone;
splitting said received video/audio streams to separate video and audio streams using a audio and video adder/splitter module in said legacy IP phone;
routing said video streams to said CDD using a routing module; and
displaying said video streams using at least one output interface associated with said CDD, wherein said at least one output interface is a browser.

13. The system as in claim 1, wherein said system is further configured to capture video streams to be transmitted using said CDD by:
sending command to capture said video streams to said CDD using a signalling module in said legacy IP phone;
capturing said video streams upon receiving said command from said legacy IP phone, using a supporting hardware associated with said CDD; and
transmitting said captured video streams to said legacy IP phone using a communication module in said CDD.

14. A method for providing video support for legacy IP phone, said method comprises of:
configuring said legacy IP phone with a Companion Display Device (CDD);
initiating said configured CDD upon detecting a call initiation request;
displaying incoming video streams using said CDD; and
capturing video streams to be transmitted, using said CDD.

15. The method as in claim 14, wherein configuring said CDD with said legacy IP phone involves registering said CDD with said legacy IP phone.

16. The method as in claim 15, wherein said CDD is manually registered with said legacy IP phone.

17. The method as in claim 16, wherein manually registering said CDD with said legacy IP phone further comprises of:
configuring at least one parameter specific to said Legacy IP phone with said CDD;
sending a device registration request from said CDD to said legacy IP phone;
registering said CDD with said legacy IP phone, upon receiving said device registration request from said CDD; and
sending a registration acknowledgement to said CDD from said legacy IP phone.

18. The method as in claim 15, wherein said CDD is automatically registered with said legacy IP phone.

19. The method as in claim 18, wherein automatically registering said CDD with said legacy IP phone is initiated from said legacy IP phone.

20. The method as in claim 19, wherein initiating said automatic registration of said CDD with said legacy IP phone from said legacy IP phone further comprises of:
sending a device discovery message to at least one CDD from said legacy IP phone;
receiving said device discovery message from said legacy IP phone using said at least one CDD;
registering said legacy IP phone with each of said plurality of CDDs, wherein said registration involves configuring at least one parameter specific to said Legacy IP phone with said at least one CDD; and
sending registration acknowledgement to said legacy IP phone from said at least one CDD.

21. The method as in claim 18, wherein automatically registering said CDD with said legacy IP phone is initiated from said CDD.

22. The method as in claim 19, wherein initiating said automatic registration of said CDD with said legacy IP phone from said CDD further comprises of:
sending a device discovery message to at least one legacy IP phone from said CDD using said CDD;
receiving said device discovery message from said CDD by said at least one legacy IP phone;
registering said CDD with said at least one legacy IP phone, wherein said registration involves configuring at least one parameter specific to said CDD with said at least one legacy IP phone; and
sending registration acknowledgement to said CDD from said at least one legacy IP phone.

23. The method as in claim 14, wherein said call initiation request corresponds to a video call.

24. The method as in claim 14, wherein initiating said CDD further comprises of sending a START message from said legacy IP phone.

25. The method as in claim 14, wherein displaying said incoming video streams using said CDD further comprises of:
terminating video/audio streams received from a communication device at said legacy IP phone;
splitting said received video/audio streams to separate video and audio streams at said legacy IP phone;
routing said video streams to said CDD using from said legacy IP phone; and
displaying said video streams using said CDD.

26. The method as in claim 25, wherein said video streams are displayed using a browser.

27. The method as in claim 14, wherein capturing said video streams to be transmitted using said CDD further comprises of:
sending command to capture said video streams to said CDD from said legacy IP phone;
capturing said video streams upon receiving said command from said legacy IP phone, using said CDD; and
transmitting said captured video streams to said legacy IP phone from said CDD.
